(19) United States
(12) Patent Application Publication
(10) Pub. No.: US 2023/0303813 A1
(43) Pub. Date: Sep. 28, 2023

(54) PROPYLENE RESIN COMPOSITION

(71) Applicant: IDEMITSU KOSAN CO.,LTD., Chiyoda-ku (JP)

(72) Inventors: Nozomu FUJII, Sumida-ku (JP); Masaki OKANO, Chiba-shi (JP); Asami KOGA, Taito-ku (JP)

(73) Assignee: IDEMITSU KOSAN CO.,LTD., Chiyoda-ku (JP)

(21) Appl. No.: 18/041,231

(22) PCT Filed: Aug. 25, 2021
(86) PCT No.: PCT/JP2021/031077

§ 371 Date: Feb. 10, 2023

(30) Foreign Application Priority Data
Aug. 26, 2020 (JP) 2020-142888

(51) Int. Cl. C08L 23/12; C09J 123/12

(52) U.S. Cl. CPC C08L 23/12; C09J 123/12; C08L 2205/025

(57) ABSTRACT

A propylene resin composition containing a propylene homopolymer that satisfies conditions (1) to (3) described below, and having a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.

### TECHNICAL FIELD

The present invention relates to a propylene resin composition and a hot-melt adhesive containing the propylene resin composition.

### BACKGROUND ART

A hot-melt adhesive is a solvent-free adhesive, and is applied on an adherend through heat-melting and is then solidified by cooling, thus exhibiting adhesiveness. In recent years, use of a hot-melt adhesive has been expanded in various fields due to its superior high-speed coating, fast curability, solvent-free property, barrier property, energy saving property, and economic efficiency.

In application of a hot-melt adhesive in various fields, a superior adhesiveness is sometimes demanded under a wide range of temperature conditions. In response to the demand, the technological development has conventionally been made for enhancing heat resistance of a hot-melt adhesive (PTL 1).

### CITATION LIST

### Patent Literature

PTL 1: JP 2011-511866 T

### SUMMARY OF INVENTION

### Technical Problem

However, for example, in the case of a hot-melt adhesive containing a polyolefin, such as polypropylene, as a base polymer, wettability to an adherend is not enough and it has been difficult to obtain a desired bonding strength.

For compensating this, a tackifying resin is sometimes added to enhance the bonding strength of a hot-melt adhesive. However, when a large amount of a tackifying resin is added, the heat resistance of the hot-melt adhesive is reduced and it has been difficult to maintain the adhesiveness under high temperature conditions.

In addition, in a manufacturing environment in which an adherend with a hot-melt adhesive applied thereon is allowed to stand for a certain period of time before bonding, in other words, in a manufacturing environment involving a long open time, it has been difficult to achieve a desired heat resistance.

Accordingly, a problem that the present invention is to solve is to provide a propylene resin composition that stably exhibits a good adhesiveness even under high temperature conditions, and that exhibits a high heat resistance even when a long open time is provided, and to provide a hot-melt adhesive containing the propylene resin composition.

### Solution to Problem

The present disclosure relates to a propylene resin composition as described below and a hot-melt adhesive containing the propylene resin composition.
<1> A propylene resin composition containing a propylene homopolymer (A) that satisfies conditions (1) to (3) described below, and having a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.
<2>The propylene resin composition according to the above <1>, wherein the propylene homopolymer (A) is contained in an amount of 40% by mass or more and less than 98% by mass.
<3> The propylene resin composition according to the above <1> or <2>, further containing a propylene-based polymer (B) that has a melting point higher than 120° C.
<4> The propylene resin composition according to the above <3>, wherein the propylene-based polymer (B) is an acid-modified propylene-based polymer.
<5> The propylene resin composition according to the above <3> or <4>, wherein the propylene-based polymer (B) is a maleic acid-modified propylene-based polymer.
<6> The propylene resin composition according to the above <3>, wherein the propylene-based polymer (B) is an unmodified propylene-based polymer that has a weight average molecular weight (Mw) of 40,000 or more.
<7> The propylene resin composition according to any one of the above <3> to <6>, wherein the propylene-based polymer (B) is contained in an amount of 1 to 40% by mass.
<8> The propylene resin composition according to any one of the above <1> to <7>, further containing an ethylene-based polymer (C) in an amount of 1 to 50% by mass.
<9> The propylene resin composition according to any one of the above <1> to <8>, having a peel adhesion failure temperature (PAFT) of 70° C. or higher.
<10> The propylene resin composition according to the above <1>, wherein the propylene homopolymer (A) is contained in an amount of 98% by mass or more and the melting point (Tm-D) of the propylene homopolymer (A) is 95° C. or higher.
<11> A hot-melt adhesive containing the propylene resin composition according to any one of the above <1> to <10>.

### Advantageous Effects of Invention

The propylene resin composition of the present invention stably exhibits a good adhesiveness under high temperature conditions. The propylene resin composition of the present invention also exhibits an excellent heat resistance even when a long open time is provided.

### DESCRIPTION OF EMBODIMENTS

The present invention will be described in detail below. In this description, a phrase “A to B” regarding a description of a numerical value means “A or more and B or less” (in the case of A<B) or “A or less and B or more” (in the case of A>B). In the present invention, a combination of preferred aspects is a more preferred aspect.

### Propylene Resin Composition

A propylene resin composition of this embodiment contains a propylene homopolymer (A) satisfying conditions (1) to (3) described below, and has a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.

Among such propylene resin compositions, when the propylene homopolymer (A) is contained in an amount of 98% by mass or more, the melting point (Tm-D) thereof is preferably 95° C. or higher. Specifically, when the propylene homopolymer (A) is contained in an amount of 98% by mass or more, it is preferred that the propylene resin composition of this embodiment satisfies the conditions (1) to (3) as described below, contains the propylene homopolymer (A) having a melting point (Tm-D) of 95° C. or higher in an amount of 98% by mass or more, and has a peel adhesion failure temperature (PAFT) of 70° C. or higher and a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.

### Propylene Homopolymer (A)

The propylene homopolymer (A) contained in the propylene resin composition of this embodiment has a melting point (Tm-D) of 120° C. or lower, a molecular weight distribution (Mw/Mn) less than 3.0, and a melt viscosity at 190° C. of 30,000 mPa·s or less.

The melting point (Tm-D) of the propylene homopolymer (A) is, from the viewpoint of the flowability and the viewpoint of the coatability in use in a hot-melt adhesive or the like, 120° C. or lower, preferably 115° C. or lower. From the same points of view, the melting point (Tm-D) is preferably 0° C. or higher, more preferably 40° C. or higher, further preferably 60° C. or higher.

When the propylene resin composition of this embodiment contains the propylene homopolymer (A) in an amount of 98% by mass or more, from the viewpoint of the flowability and the viewpoint of the coatability in use in a hot-melt adhesive or the like, the melting point (Tm-D) of the propylene homopolymer (A) is preferably 95° C. or higher. Specifically, when the propylene resin composition of this embodiment contains the propylene homopolymer (A) in an amount of 98% by mass or more, the melting point (Tm-D) of the propylene homopolymer (A) is 120° C. or lower, preferably 115° C. or lower, and preferably 95° C. or higher, more preferably 97° C. or higher, further preferably 100° C. or higher.

When the content of the propylene homopolymer (A) in the propylene resin composition of this embodiment is 40% by mass or more and less than 98% by mass, the melting point (Tm-D) of the propylene homopolymer (A) is 120° C. or lower, preferably 115° C. or lower, and preferably 0° C. or higher, more preferably 40° C. or higher, further preferably 60° C. or higher, furthermore preferably 80° C. or higher.

The melting point can be controlled by appropriately adjusting the monomer concentration or the reaction pressure.

In this embodiment, using a diffraction scanning calorimeter (DSC), a sample is kept at −40° C. under a nitrogen atmosphere for 5 minutes and then the temperature is increased at 10° C./minute to obtain a melting endothermic curve, and in the melting endothermic curve, the peak top of a peak observed at the highest temperature is defined as the melting point (Tm-D).

The weight average molecular weight (Mw) of the propylene homopolymer (A) is, from the viewpoint of the flowability and the viewpoint of the coatability in use in a hot-melt adhesive or the like, preferably 20,000 or more, more preferably 22,000 or more, further preferably 25,000 or more, and preferably 72,000 or less, more preferably 70,000 or less, further preferably 67,000 or less.

The molecular weight distribution (Mw/Mn) of the propylene homopolymer (A) is less than 3.0, preferably 2.5 or less, and preferably 1.0 or more, more preferably 1.5 or more. With a molecular weight distribution (Mw/Mn) in the above range, a high heat-creeping resistance can be achieved.

In this embodiment, the weight average molecular weight (Mw) and the molecular weight distribution (Mw/Mn) are values based on polypropylene determined by gel permeation chromatography (GPC). Specifically, the following apparatuses and conditions are used in the measurement to determine the weight average molecular weight (Mw) and the number average molecular weight (Mn) based on polypropylene, and the molecular weight distribution (Mw/Mn) is a value calculated from the weight average molecular weight (Mw) and the number average molecular weight (Mn).

### GPC Apparatus

Instrument: “HLC8321GPC/HT” manufactured by Tosoh Corporation
Detector: RI detector
Column: 2×“TOSOH GMHHR-H(S)HT” manufactured by Tosoh Corporation

### Measurement Conditions

Solvent: 1,2,4-trichlorobenzene
Measurement temperature: 145° C.
Flow rate: 1.0 mL/minute
Sample concentration: 0.5 mg/mL
Injection: 300 μL
Calibration curve: created using PS standards.
Molecular weight conversion: converted using a universal calibration method.

### αPS: 0.707, κPS: 0.00121, αPP: 0.750, κPP: 0.0137

Analytical program: 8321GPC-WS

The propylene homopolymer (A) has a melting viscosity at 190° C. of 30,000 mPa·s or less, preferably 25,000 mPa·s or less, more preferably 23,000 mPa·s or less, and preferably 1,000 mPa·s or more, more preferably 1,500 mPa·s or more. With a melting viscosity in the above range, the flowability in melting of the propylene resin composition is improved and the coatability when used in a hot-melt adhesive or the like is improved.

In this embodiment, the melting viscosity is measured at 190° C. using a Brookfield rotary viscometer according to JIS K6862.

The propylene homopolymer (A) preferably has a glass transition temperature (Tg) of −15° C. or higher, more preferably −10° C. or higher, further preferably −7° C. or higher, and preferably 25° C. or lower, more preferably 20° C. or lower, further preferably 15° C. or lower. With a glass transition temperature (Tg) in this range, the cohesion thereof in use in a hot-melt adhesive or the like is increased, and even if the amount of the tackifying resin added is small or no tackifying resin is used, a sufficient bonding strength is achieved.

In this embodiment, the glass transition temperature (Tg) is a value determined as follows. Using a viscoelasticity measurement apparatus DMA7100 manufactured by Hitachi High-Tech Science Corporation, a sample is kept at −150° C. under a nitrogen atmosphere for 5 minutes and then the temperature is increased at 5° C./minute to obtain a loss tangent (tan δ) curve of the dynamic viscoelasticity. Then, a value of a peak top observed in the curve is taken.

The propylene homopolymer (A) is preferably produced using a metallocene catalyst. By using a metallocene catalyst, a propylene homopolymer satisfying the range of the molecular weight distribution (Mw/Mn) described above can be obtained.

For example, a metallocene catalyst as described in WO 2003/087172 can be used. In particular, a metallocene catalyst obtained by using a transition metal compound in which a ligand forms a crosslinking structure via a crosslinking group is preferred, and among such compounds, a metallocene catalyst obtained by combining a transition metal compound in which a crosslinking structure is formed via two crosslinking groups and a co-catalyst is especially preferred.

As the propylene homopolymer (A), a commercial product can be used. Specific examples thereof include “S400”, “S401”, and “S410” (all are a trade name) of “L-MODU” (registered tradename) (from Idemitsu Kosan Co., Ltd.).

### Propylene-Based Polymer (B)

The propylene resin composition of this embodiment preferably contains a propylene-based polymer (B) that has a melting point higher than 120° C.

The melting point (Tm-D) of the propylene-based polymer (B) is preferably higher than 120° C., more preferably 125° C. or higher, further preferably 127° C. or higher, and preferably 180° C. or lower, more preferably 170° C. or lower.

With a melting point in this range, a good heat-creeping resistance is achieved.

As the propylene-based polymer (B), one propylene-based polymer may be used alone or two or more propylene-based polymers may be used in combination as long as the melting point is in the above range.

The propylene-based polymer (B) is preferably at least one selected from the group consisting of a modified propylene-based polymer and an unmodified propylene-based polymer, and from the viewpoint of improving the bonding strength and the peel adhesion failure temperature with a small addition amount, is more preferably a modified propylene-based polymer, and from the viewpoint of improving the bonding strength and the peel adhesion failure temperature without causing an odor, is more preferably an unmodified propylene-based polymer.

The modified propylene-based polymer is preferably an acid-modified propylene-based polymer, more preferably a maleic acid-modified propylene-based polymer.

When the propylene-based polymer (B) is a modified propylene-based polymer, a polarity can be imparted to the propylene resin composition. It is considered that the polarity imparted increases the interfacial strength between the propylene resin composition and an adherend, which leads to an increase of the peel adhesion failure temperature.

The propylene-based polymer (B) is not particularly limited, and is a polymer having propylene as a main monomer, preferably a propylene homopolymer or a propylene-based copolymer. The propylene-based copolymer is preferably a copolymer of propylene and ethylene or an olefin having 4 to 8 carbon atoms, more preferably a copolymer of propylene and ethylene or 1-butene, further preferably a copolymer of propylene and ethylene.

When the propylene-based polymer (B) is an unmodified propylene-based polymer, the weight average molecular weight (Mw) of the propylene-based polymer (B) is preferably 40,000 or more, more preferably 50,000 or more, further preferably 100,000 or more, and from the viewpoint of the kneadability, is preferably 400,000 or less, more preferably 300,000 or less, further preferably 200,000 or less.

It is considered that, with a weight average molecular weight (Mw) of the propylene-based polymer (B) within the above range, entanglements among polymer chains are increased to retard stress relaxation, thus improving the peel adhesion failure temperature.

When the propylene-based polymer (B) is a modified propylene-based polymer, the weight average molecular weight (Mw) of the propylene-based polymer (B) is not particularly limited, and may be in the same range as for the aforementioned unmodified propylene-based polymer.

As the propylene-based polymer (B), a commercial product can be used.

Specific examples of the modified propylene-based polymer that can be suitably used as the propylene-based polymer (B) include “HI-WAX”, “ADMER” (from Mitsui Chemicals, Inc.), “Licocene” (from Clariant), “A-C” (from Honeywell), “RIKEAID” (from RIKEN VITAMIN Co., Ltd.), “UMEX” (from Sanyo Chemical Industries, Ltd.), “MODIC” (from Mitsubishi Chemical Corporation) (all are a trade name).

Specific examples of the unmodified propylene-based polymer that is suitably used as the propylene-based polymer (B) include “Prime Polypro” (from Prime Polymer Co., Ltd.), “NOVATEC” (from Japan Polypropylene Corporation), and “Mopine” (from Lyndellbasell) (all are a trade name).

### Ethylene-Based Polymer (C)

The propylene resin composition of this embodiment may contain an ethylene-based polymer (C). By containing the ethylene-based polymer (C), the propylene resin composition becomes soft.

From the viewpoint of the softness, the ethylene-based polymer preferably has a melting endothermic energy amount (ΔH-D) of 0 J/g or more, more preferably 20 J/g or more, further preferably 40 J/g or more, and preferably 120 J/g or less, more preferably 100 J/g or less, further preferably 80 J/g or less.

In this embodiment, the melting endothermic energy amount is determined as follows. Using a diffraction scanning calorimeter (DSC), a sample is kept at −40° C. under a nitrogen atmosphere for 5 minutes, then the temperature is increased at 10° C./minute to obtain a melting endothermic curve. In the melting endothermic curve, a line connecting a point with no change in the energy amount on the lower temperature side of a peak and a point with no change in the energy amount on the higher temperature side of the peak is taken as a base line, and the area surrounded by the peak and the base line is determined. The area is taken as the melting endothermic energy amount (ΔH-D).

From the viewpoint of the coatability, the melting point (Tm-D) of the ethylene-based polymer is preferably 30° C. or higher, more preferably 50° C. or higher, and preferably less than 85° C., more preferably 80° C. or lower.

The ethylene-based polymer (C) is an ethylene homopolymer or an ethylene-based copolymer. The ethylene-based copolymer is a copolymer of ethylene and a copolymerizable monomer that can be copolymerized with ethylene. Examples of the copolymerizable monomer include an α-olefin; carboxylic acids (esters), such as vinyl acetate, (meth)acrylic acid, a (meth)acrylic acid ester, maleic acid, and a maleic acid ester; and carboxylic acid anhydrides, such as maleic anhydride, phthalic anhydride, and succinic anhydride. One of the copolymerizable monomers may be copolymerized alone with ethylene, or two or more copolymerizable monomers may be copolymerized. Examples of the ethylene-based copolymer include an ethylene/α-olefin copolymer, an ethylene/carboxylic acid copolymer, an ethylene/carboxylic acid ester copolymer, and an ethylene/carboxylic acid anhydride copolymer.

In this description, (meth)acrylic acid refers to a concept including both of methacrylic acid and acrylic acid. Specific examples of the (meth)acrylic acid ester include methyl acrylate, ethyl acrylate, n-propyl acrylate, n-butyl acrylate, isobutyl acrylate, 2-ethylhexyl acrylate, 2-hydroxyethyl acrylate, isooctyl acrylate, methyl methacrylate, ethyl methacrylate, and glycidyl methacrylate.

From the viewpoint of the adhesiveness and odor of a hot-melt adhesive, the ethylene-based polymer (C) preferably contains at least one constitutional unit selected from the group consisting of α-olefins having 3 to 30 carbon atoms (preferably 3 to 10 carbon atoms) in an amount of more than 0% by mole and 40% by mole or less. The ethylene-based polymer is preferably an ethylene/α-olefin copolymer, and preferably a copolymer of ethylene and an α-olefin having 3 to 30 carbon atoms (preferably 3 to 10 carbon atoms). The ethylene-based polymer is also preferably an ethylene/α-olefin copolymer obtained by polymerization with a metallocene catalyst. Specific examples of the α-olefin include propylene, 1-butene, 1-pentene, 4-methyl-1-pentene, 1-hexene, 1-octene, 1-decene, 1-dodecene, 1-tetradecene, 1-hexadecene, 1-octadecene, and 1-eicocene. In the present invention, one or two or more thereof can be used. Among the α-olefins, propylene or 1-octene is preferred. The ethylene-based polymer used in the present invention is, from the viewpoint of the adhesiveness, more preferably an ethylene-1-octene copolymer, further preferably an ethylene-1-octene copolymer containing 5 to 20% by mole of a constitutional unit derived from 1-octene.

When the propylene resin composition of this embodiment contains an ethylene/α-olefin copolymer obtained by polymerization with a metallocene catalyst, the coatability in use in a hot-melt adhesive is improved and in addition, the propylene resin composition can have a high heat-creeping resistance.

As the ethylene-based polymer (C), a commercial product can be used. Specific examples of the ethylene-based polymer (C) include “Exact” series (from Exxon Mobil Corporation), “Affinity” series, and “Infuse” series (from Dow Chemical), more preferably “Affinity GA1875”, “Affinity GA1900”, “Affinity GA1950”, “Affinity GP1570”, “Infuse 9807”, and “Infuse 9817” (from Dow Chemical) (all are a trade name).

### Other Additives

The propylene resin composition of this embodiment may further contain various additives, such as a tackifying resin, an oil, a wax, another plasticizer, an inorganic filler, and an antioxidant, as required, to the extent that the effect of the present invention is not impaired.

Examples of the tackifying resin include resins that are in a solid, a semisolid, or a liquid form at normal temperature, such as a hydrogenated derivative of an aliphatic hydrocarbon petroleum resin, a rosin derivative resin, a polyterpene resin, a petroleum resin, and an oil-soluble phenol resin. Specific examples thereof include a natural rosin, a modified rosin, a hydrogenated rosin, a natural rosin glycerol ester, a modified rosin glycerol ester, a natural rosin pentaerythritol ester, a modified rosin pentaerythritol ester, a hydrogenated rosin pentaerythritol ester, a natural terpene copolymer, a natural terpene three dimensional polymer, a hydrogenated derivative of a hydrogenated terpene copolymer, a polyterpene resin, a hydrogenated derivative of a phenol-modified terpene resin, an aliphatic petroleum hydrocarbon resin, a hydrogenated derivative of an aliphatic petroleum hydrocarbon resin, an aromatic petroleum hydrocarbon resin, a hydrogenated derivative of an aromatic petroleum hydrocarbon resin, a cyclic aliphatic petroleum hydrocarbon resin, and a hydrogenated derivative of a cyclic aliphatic petroleum hydrocarbon resin. One of them may be used alone or two or more thereof may be used in combination. In this embodiment, in view of the compatibility with the propylene homopolymer (A), the hydrogenated product is preferably used. Among them, a hydrogenated product of a petroleum resin superior in thermal stability is more preferred.

As the tackifying resin, a commercial product can be used.

Examples of a tackifying resin produced using a crude oil and a raw material obtained in a naphtha refining process include “I-MARV” (from Idemitsu Kosan Co., Ltd.), “Arkon” (from Arakawa Chemical Industries, Ltd.), “Quinton” (from Zeon Corporation), “T-REZ” (from ENEOS Corporation), “Escorez” and “Oppera” (all from ExxonMobil Chemical Corporation), “Eastotac”, “Regalite”, “Regalrez”, and “Plastolyn” (all from Eastman Chemical Company), “Sukolez” (from Kolon Corporation), and “Wingtack” and “Norsolene” (all from Cray Valley Corporation) (all are a trade name).

Examples of a tackifying resin produced using an essential oil derived from orange or the like as a raw material include “Clearon” (from Yasuhara Chemical Co., Ltd.), and “Sylvalite” and “Sylvares” (from Arizona Chemical Corporation) (all are a trade name).

Examples of a tackifying resin produced using a rosin or the like as a raw material include “Haritack” and “Neotall” (from Harima Chemicals Group, Inc.), and “Ester Gum” and “Pensel” (from Arakawa Chemical Industries, Ltd.) (all are a trade name).

The softening point of the tackifying resin is not particularly limited. However, when the softening point is too high, the coatability worsens in use as a hot-melt adhesive due to increased viscosity, and when the softening point is too low, the heat stability of a hot-melt adhesive worsens and burning occurs in a melter to have some negative influence on the adhesiveness and odor. For the above reasons, the softening point of the tackifying resin is preferably 80° C. or higher, more preferably 85° C. or higher, further preferably 90° C. or higher, and preferably 150° C. or lower, more preferably 140° C. or lower, further preferably 125° C. or lower.

When the propylene resin composition contains a tackifying resin, the content thereof based on 100 parts by mass of the total amount of the propylene homopolymer (A) and the propylene-based polymer (B) is preferably 1 to 25 parts by mass, preferably 1 to 22 parts by mass, more preferably 1 to 20 parts by mass, based on 100 parts by mass of the total amount of the propylene homopolymer (A) and the propylene-based polymer (B).

Examples of the oil include a mineral oil, an aromatic mineral oil-based hydrocarbon, a synthetic resin-based hydrocarbon, an alkylbenzene, a fatty oil-based softening agent, and an ester-type plasticizer.

Examples of the mineral oil include a paraffinic process oil, a naphthenic process oil, and an isoparaffinic oil.

Examples of the synthetic resin-based hydrocarbon include low molecular substances, such as polybutene, polyisobutylene, polybutadiene, and a poly(α-olefin).

Examples of the fatty oil-based softening agent include caster oil, linseed oil, rape seed oil, and coconut oil.

Examples of the ester-type plasticizer include dibutyl phthalate, dioctyl phthalate, dioctyl adipate, and dioctyl sebacate.

Examples of the wax include an animal wax, a plant wax, carnauba wax, candelilla wax, Japan wax, bees wax, mineral wax, petroleum wax, paraffin wax, microcrystalline wax, petrolatum, a higher fatty acid wax, a higher fatty acid ester wax, and Fischer-Tropsch wax.

Examples of another plasticizer include a phthalic acid ester, an adipic acid ester, a fatty acid ester, a glycol, and an epoxy polymer plasticizer.

Examples of the inorganic filler include barium carbonate, wollastonite, silica, cray, mica, kaolin, titanium oxide, diatom earth, a urea resin, styrene bead, starch, barium sulfate, calcium sulfate, magnesium silicate, magnesium carbonate, alumina, and quartz powder.

Examples of the antioxidant include phosphorus-based antioxidants, such as trisnonylphenyl phosphite, distearylpentaerythritol dip hosp hite, “Adekastab 1178” (from ADEKA Corporation), “Sumilizer TNP” (from Sumitomo Chemical Co., Ltd.), “Irgafos 168” (from BASF Corporation), and “Sandstab P-EPQ” (from Sandoz K.K.); phenol-based antioxidants, such as 2, 6-di-t-butyl-4-methylphenol, n-octadecyl-3-(3′,5′-di-t-butyl-4′-hydroxyphenyl) propionate, “Sumilizer BHT” (from Sumitomo Chemical Co., Ltd.), and “Irganox 1010” (from BASF Corporation); and sulfur-based antioxidants, such as dilauryl-3,3′-thiodipropionate, pentaerythritol tetrakis(3-laurylthiopropionate), “Sumilizer TPL” (from Sumitomo Chemical Co., Ltd.), “DLTP “Yoshitomi”” (from Mitsubishi Chemical Corporation), and “AntiOx L” (from NOF Corporation).

### Characteristics and Composition of Propylene Resin Composition

As described above, the propylene resin composition of this embodiment contains the propylene homopolymer (A) satisfying the conditions (1) to (3) as described below and has a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.

By satisfying the conditions, the propylene resin composition of this embodiment has a high heat-creeping resistance (heat resistance). An example of a measure for evaluating the heat-creeping resistance is a peel adhesion failure temperature (PAFT).

Here, the peel adhesion failure temperature (PAFT) refers to a temperature at which a test piece bonded with a hot-melt adhesive or the like is dissociated when the temperature is increased under a certain static load toward a peeling direction (180° peeling direction).

The peel adhesion failure temperature (PAFT) in this description is a value measured by a method according to ASTM D-4498, specifically, by a method described in the section of Examples.

The peel adhesion failure temperature (PAFT) is a value determined by a measurement method in which a force is applied in a peeling direction (180° peeling direction), and PAFT is measured by a method in which a force is concentrated in a tip portion of a bonded part. Since the entire load is thus topically exerted, a high bonding strength at a high temperature is required. In an actual product, such a bonding strength is important and a high peel adhesion failure temperature (PAFT) is required.

The peel adhesion failure temperature (PAFT) of the propylene resin composition of this embodiment is, from the viewpoint of stably exhibiting a good adhesiveness under high temperature conditions, preferably 70° C. or higher, more preferably 75° C. or higher, further preferably 80° C. or higher, furthermore preferably 85° C. or higher. The upper limit is not particularly limited, and a higher peel adhesion failure temperature (PAFT) leads to a higher adhesiveness under high temperature conditions. Thus, when the propylene resin composition of the present invention is used in a hot-melt adhesive, a stable adhesiveness is achieved regardless of the temperature in bonding and thus, the hot-melt adhesive can be used for bonding in a wide variety of applications. Note that the upper limit of the peel adhesion failure temperature (PAFT) is not limited as described above, but, for example, may be 200° C. or lower, or may be 180° C. or lower.

In the measurement of the peel adhesion failure temperature (PAFT), an open time is generally provided in production of a bonding test piece. Here, the PAFT is sometimes affected by the open time. For example, when an adherend bonding process using an adhesive is employed on a production line, the open time is determined depending on the speed of the production line. Specifically, a higher speed of the production line leads to a shorter open time.

The peel adhesion failure temperature (PAFT) of the propylene resin composition of this embodiment can be measured in any open time. Preferably, a time appropriately selected in the range of more than 0 second and less than 30 seconds, more preferably, any time of 2 seconds, 3 seconds, 4 seconds, 5 seconds, 6 seconds, 7 seconds, 8 seconds, 9 seconds, 10 seconds, 11 seconds, 12 seconds, 13 seconds, 14 seconds, 15 seconds, 16 seconds, 17 seconds, 18 seconds, 19 seconds, and 20 seconds, further preferably any time of 13 seconds, 14 seconds, 15 seconds, 16 seconds, 17 seconds, and 18 seconds, and furthermore preferably any time of 14 seconds, 15 seconds, and 16 seconds can be set.

The semicrystallization time (t_{1/2}) of the propylene resin composition of the present invention is 60 seconds or more, preferably 65 seconds or more, more preferably 70 seconds or more, and preferably 800 seconds or less, more preferably 700 seconds or less, further preferably 600 seconds or less, furthermore preferably 300 seconds or less. It is considered that, with a semicrystallization time (t_{1/2}) in this range, the wettability to an adherend is superior in use in a hot-melt adhesive or the like and a sufficient bonding strength is achieved. In particular, it is considered that a superior adhesiveness is then exhibited at high temperatures.

In this embodiment, the semicrystallization time (t_{1/2}) was measured using a diffraction scanning calorimeter DSC-7 manufactured by PerkinElmer, Co., Ltd. by keeping 10 mg of a sample at 220° C. under a nitrogen atmosphere for 5 minutes, then decreasing the temperature to 25° C. at 320° C./minute, then keeping the temperature for 30 minutes to measure the variation in calorific value in an isothermal crystallization process. Specifically, the semicrystallization time is such a time that, when a line connecting two points with no change in the calorific value is taken as a base line, an area surrounded by a line segment containing a peak in a crystallization exothermic curve obtained by a DSC measurement, the base line, and a vertical line relative to the base line is half of the peak area.

The melting viscosity at 190° C. of the propylene resin composition of this embodiment is preferably 50,000 mPa·s or less, more preferably 40,000 mPa·s or less, further preferably 30,000 mPa·s or less, and preferably 1,000 mPa·s or more. With a melting viscosity in this range, the flowability in melting of the propylene resin composition is improved and the coatability in use in a hot-melt adhesive is improved.

The propylene resin composition of this embodiment includes a propylene resin composition of a first embodiment in which the content of components other than the propylene homopolymer (A) is 2% by mass or less, and a propylene resin composition of a second embodiment in which the content of polymers and the like other than the propylene homopolymer (A) is more than 2% by mass.

The first embodiment is a case where the propylene resin composition of this embodiment contains the propylene homopolymer (A) in an amount of 98% by mass or more, as described in the section of <Propylene homopolymer (A)>. The second embodiment includes a case where the propylene resin composition of this embodiment contains the propylene homopolymer (A) in an amount of 40% by mass or more and less than 98% by mass, as described in the section of the <Propylene homopolymer (A)>.

The propylene resin composition of the second embodiment preferably contains the propylene-based polymer (B). The propylene resin composition of the second embodiment includes a propylene resin composition of a third embodiment that contains propylene-based polymer (B) that is a modified propylene-based polymer and a propylene resin composition of a fourth embodiment that contains the propylene-based polymer (B) that is an unmodified propylene-based polymer.

Hereinunder, the propylene resin composition of the first embodiment will be described. In addition, the propylene resin composition of the third embodiment and the propylene resin composition of the fourth embodiment which is a suitable propylene resin composition among the propylene resin compositions of the second embodiment will be described.

### Propylene Resin Composition of First Embodiment

The content of the propylene homopolymer (A) in the propylene resin composition of the first embodiment is, from the viewpoint of improving the physical properties (for example, breaking elongation or breaking strength) and the glass transition temperature, preferably 98% by mass or more and 100% by mass or less in the propylene resin composition, more preferably 99% by mass or more and 100% by mass or less, further preferably 100% by mass.

The melting point (Tm-D) of the propylene homopolymer (A) in the propylene resin composition of the first embodiment is 120° C. or lower, preferably 115° C. or lower, and, from the viewpoint of the flowability and the viewpoint of the coatability in use in a hot-melt adhesive or the like, preferably 95° C. or higher, more preferably 97° C. or higher, further preferably 100° C. or higher.

The content of the propylene-based polymer (B) in the propylene resin composition of the first embodiment is preferably 2% by mass or less in the propylene resin composition, more preferably 1% by mass or less, and further preferably the propylene-based polymer (B) is not contained.

The content of the ethylene-based polymer (C) in the propylene resin composition of the first embodiment is preferably 2% by mass or less in the propylene resin composition, more preferably 1% by mass or less, and further preferably the ethylene-based polymer (C) is not contained.

### Propylene Resin Composition of Third Embodiment

The content of the propylene homopolymer (A) in the propylene resin composition of the third embodiment is, from the viewpoint of improving the physical properties (for example, breaking elongation or breaking strength) and the glass transition temperature, preferably 40% by mass or more and less than 98% by mass in the propylene resin composition, more preferably 50% by mass or more, further preferably 60% by mass or more, and more preferably 95% by mass or less, further preferably 90% by mass or less, furthermore preferably 85% by mass or less, furthermore preferably 80% by mass or less.

The propylene-based polymer (B) in the propylene resin composition of the third embodiment is, from the viewpoint of improving the bonding strength and the peel adhesion failure temperature with a small addition amount, a modified propylene-based polymer, preferably an acid-modified propylene-based polymer, more preferably a maleic acid-modified propylene-based polymer.

When the propylene-based polymer (B) is a modified propylene-based polymer, a polarity can be imparted to the propylene resin composition. It is considered that the polarity imparted increases the interfacial strength between the propylene resin composition and an adherend, which leads to an increase of the peel adhesion failure temperature.

The content of the propylene-based polymer (B) in the propylene resin composition of the third embodiment is, from the viewpoint of improving the heat-creeping resistance, preferably 1% by mass or more in the propylene resin composition, more preferably 2% by mass or more, further preferably 5% by mass or more, furthermore preferably 10% by mass or more, furthermore preferably 15% by mass or more, furthermore preferably 20% by mass or more, and preferably 60% by mass or less, more preferably 50% by mass or less, further preferably 40% by mass or less.

In particular, from the viewpoint of suppressing an odor while maintaining the heat-creeping resistance, the content of the propylene-based polymer (B) in the propylene resin composition of the third embodiment is preferably 1% by mass or more in the propylene resin composition, more preferably 2% by mass or more, further preferably 3% by mass or more, furthermore preferably 5% by mass or more, furthermore preferably 10% by mass or more, furthermore preferably 13% by mass or more, and preferably 40% by mass or less, more preferably 30% by mass or less, further preferably 20% by mass or less.

The mass ratio [(A)/(B)] of the propylene homopolymer (A) to the propylene-based polymer (B) in the propylene resin composition of the third embodiment is, from the viewpoint of improving the heat-creeping resistance, preferably 40/60 to 98/2, more preferably 50/50 to 95/5, further preferably 60/40 to 90/10, furthermore preferably 60/40 to 85/15, furthermore preferably 60/40 to 80/20.

In particular, from the viewpoint of suppressing an odor while maintaining the heat-creeping resistance, the mass ratio [(A)/(B)] of the propylene homopolymer (A) to the propylene-based polymer (B) in the propylene resin composition of the third embodiment is preferably 60/40 to 98/2, more preferably 60/40 to 97/3, further preferably 60/40 to 95/5, furthermore preferably 70/30 to 90/10, furthermore preferably 80/20 to 87/13.

The content of the ethylene-based polymer (C) in the propylene resin composition of the third embodiment is, from the viewpoint of improving the heat-creeping resistance, preferably 1% by mass or more in the propylene resin composition, more preferably 2% by mass or more, further preferably 3% by mass or more, and preferably 50% by mass or less, more preferably 40% by mass or less, further preferably 20% by mass or less.

### Propylene Resin Composition of Fourth Embodiment

The content of the propylene homopolymer (A) in the propylene resin composition of the fourth embodiment is, from the viewpoint of improving the physical properties (for example, breaking elongation or breaking strength) and the glass transition temperature, preferably 40% by mass or more and less than 98% by mass in the propylene resin composition, more preferably 50% by mass or more, further preferably 60% by mass or more, and more preferably 95% by mass or less, further preferably 90% by mass or less, furthermore preferably 85% by mass or less, furthermore preferably 80% by mass or less.

The propylene-based polymer (B) in the propylene resin composition of the fourth embodiment is, from the viewpoint of improving the bonding strength and the peel adhesion failure temperature without causing an odor, an unmodified propylene-based polymer, and the weight average molecular weight (Mw) of the propylene-based polymer (B) that is an unmodified propylene-based polymer is preferably 40,000 or more, more preferably 50,000 or more, further preferably 100,000 or more, and, from the viewpoint of the kneadability, preferably 400,000 or less, more preferably 300,000 or less, further preferably 200,000 or less.

The content of the propylene-based polymer (B) in the propylene resin composition of the fourth embodiment is, from the viewpoint of improving the heat-creeping resistance, preferably 1% by mass or more in the propylene resin composition, more preferably 2% by mass or more, further preferably 5% by mass or more, furthermore preferably 10% by mass or more, furthermore preferably 15% by mass or more, furthermore preferably 20% by mass or more, and preferably 60% by mass or less, more preferably 50% by mass or less, further preferably 40% by mass or less.

The mass ratio [(A)/(B)] of the propylene homopolymer (A) to the propylene-based polymer (B) in the propylene resin composition of the fourth embodiment is, from the viewpoint of improving the heat-creeping resistance, preferably 40/60 to 98/2, more preferably 50/50 to 95/5, further preferably 60/40 to 90/10, furthermore preferably 60/40 to 85/15, furthermore preferably 60/40 to 80/20.

The content of the ethylene-based polymer (C) in the propylene resin composition of the fourth embodiment is, from the viewpoint of improving the heat-creeping resistance, preferably 1% by mass or more in the propylene resin composition, more preferably 2% by mass or more, further preferably 3% by mass or more, and preferably 50% by mass or less, more preferably 40% by mass or less, further preferably 20% by mass or less.

### Production Method of Propylene Resin Composition

The propylene resin composition of this embodiment can be produced by mixing the propylene homopolymer (A), and, as required, the propylene-based polymer (B), the ethylene-based polymer (C), and various additives.

### Hot-melt Adhesive

The hot-melt adhesive of this embodiment contains the aforementioned propylene resin composition. The content of the propylene resin composition in the hot-melt adhesive is preferably 70% by mass or more, more preferably 75% by mass or more, further preferably 80% by mass or more, and preferably 100% by mass or less, more preferably 99.5% by mass or less, further preferably 99% by mass or less.

Since the hot-melt adhesive of this embodiment contains the aforementioned propylene resin composition, the hot-melt adhesive stably has a high adhesiveness even under high temperature conditions. In addition, since the hot-melt adhesive contains the propylene homopolymer (A), the hot-melt adhesive has good followability to an adherend and is superior in the adhesiveness (in particular, bonding strength) and the heat-creeping resistance.

Accordingly, the hot-melt adhesive of this embodiment can be used, not only in conventional applications, but also widely in applications in which a high heat resistance is required. For example, the hot-melt adhesive can be suitably used in bonding of car interior materials, wood products, various assembly products, sanitary goods, and the like.

### EXAMPLES

Next, the present invention will be described in more detail with reference to examples, but the present invention is in no way limited to the examples.

### Production of Propylene Homopolymer

### Production Example 1

### Production of Propylene Homopolymer (A-2)

In a 1-liter autoclave dried with heat, at room temperature under a nitrogen atmosphere, 400 mL of heptane and 2.0 mmol of triisobutylaluminum were added, the mixture was stirred, and then, 0.5 μmol of (1,2′-dimethylsilylene)(2, 1′ -dimethylsilylene)bis(3-cyclopropylmethylindenyl)zirconium dichloride was added as a catalyst species and 2.0 μmol of dimethylanilinium tetrakis(pentafluorophenyl)borate was added as a co-catalyst. Subsequently, after the autoclave was charged with 0.05 mPa of hydrogen, while increasing the temperature to 72° C. and keeping the pressure at 0.75 mPa with propylene, the mixture was subjected to polymerization for 20 minutes. After completion of the polymerization reaction, the reaction product and methanol were put in the autoclave, and the mixture was thoroughly stirred. Then, the content was dried to obtain 152 g of a propylene homopolymer (A-2).

### Raw Material

Raw materials used in Examples and Comparative Examples are as follows.

### Polymer, Such as Propylene Homopolymer (A)

(A-1) “L-MODU S400”: propylene homopolymer, from Idemitsu Kosan Co., Ltd., melting point (Tm-D)=80° C., molecular weight distribution (Mw/Mn)=2.0, melting viscosity at 190° C.=8,500 mPa·s, Mw=45,000, Tg=−2° C.
(A-2) propylene homopolymer obtained in Production Example 1: melting point (Tm-D)=102° C., molecular weight distribution (Mw/Mn)=2.4, melting viscosity at 190° C.=6,700 mPa·s, Mw=49,000, Tg=−1° C.
(a-3) “Licocene 2602”: propylene-ethylene-based copolymer, from Clariant, melting point (Tm-D)=85° C., molecular weight distribution (Mw/Mn)=2.2, melting viscosity at 190° C.=3,600 mPa·s, Mw=42,500, Tg=−24° C.
(a-4) “Koattro 1200M”: butene-ethylene-based copolymer, from Lyondell Basell, melting point (Tm-D)=82° C., molecular weight distribution (Mw/Mn)=1.7, melting viscosity at 190° C.=6,900 mPa·s, Mw=46,000, Tg=−13° C.

### Propylene-Based Polymer (B)

(B-1) “HI-WAX NP50605A”: propylene-ethylene-butene random terpolymer, maleic acid-modified, from Mitsui Chemicals, Inc., Tm-D=130° C., Mw=29,000
(B-2) “MODIC 948”: propylene-ethylene polymer, maleic acid-modified, from Mitsubishi Chemical Corporation, Tm-D=130° C., Mw=127,000
(B-3) “Y-2045GP”: propylene-ethylene-random copolymer, unmodified, from Prime Polymer Co., Ltd., Tm-D=130° C., Mw=170,000
(B-4) “HI-WAX NP506”: propylene-ethylene-butene random terpolymer, unmodified, from Mitsui Chemicals, Inc., Tm-D=130° C., Mw=26,000

### Ethylene-Based Polymer (C)

(C-1) “Affinity GA1950”: ethylene-1-octene copolymer, from Dow Chemical, ΔH-D=60 J/g, Tm-D=70° C.

### Tackifying Resin

“Escorez 5300”: DCPD hydrogenated petroleum resin, from ExxonMobil Chemical, softening point=100° C.

### Measurement of Physical Properties

Physical properties and the like of the raw materials are measured as follows.

### DSC Measurement (Melting Endothermic Energy Amount (ΔH-D), Melting Point (Tm-D))

Using a diffraction scanning calorimeter (“DSC-7” manufactured by PerkinElmer, Co., Ltd.), 10 mg of a sample was kept at −40° C. under a nitrogen atmosphere for 5 minutes, and then, the temperature was increased at 10° C./minute to obtain a melting endothermic curve, and a melting endothermic energy amount (ΔH-D) was determined from the melting endothermic curve. The melting point (Tm-D) was determined from the peak top of a peak observed at the highest temperature in the obtained melting endothermic curve.

The melting endothermic energy amount (ΔH-D) was calculated by taking a line connecting a point with no change in the calorific value on the lower temperature side and a point with no change in the calorific value on the higher temperature side as a base line, and determining an area surrounded by a line segment including a peak in the melting endothermic curve obtained by the DSC measurement using the diffraction scanning calorimeter (“DSC-7” manufactured by PerkinElmer, Co., Ltd.) and the base line.

### Weight Average Molecular Weight (Mw) and Molecular Weight Distribution (Mw/Mn)

The following apparatuses and conditions were used for measurement to determine the weight average molecular weight (Mw) and the number average molecular weight (Mn) based on polypropylene, and the molecular weight distribution (Mw/Mn) was calculated from the weight average molecular weight (Mw) and the number average molecular weight (Mn).

### Apparatus

Apparatus: “HLC8321GPC/HT” manufactured by Tosoh Corporation
Detector: RI detector
Column: 2×“TOSOH GMHHR-H(S)HT” manufactured by Tosoh Corporation

### Measurement Conditions

Solvent: 1,2,4-trichlorobenzene
Measurement temperature: 145° C.
Flow rate: 1.0 mL/minute
Sample concentration: 0.5 mg/mL
Injection: 300 μL
Calibration curve: created using PS standards.
Molecular weight conversion: converted using a universal calibration method.

### αPS: 0.707, κPS: 0.00121, αPP: 0.750, κPP: 0.0137

Analytical program: 8321GPC-WS

### Melting Viscosity at 190° C.

The melting viscosity was measured at 190° C. with a Brookfield rotary viscometer according to JIS K6862.

### Glass Transition Temperature (Tg)

Using a viscoelasticity measurement apparatus DMA7100 manufactured by Hitachi High-Tech Science Corporation, a sample was kept at −150° C. under a nitrogen atmosphere for 5 minutes, and then, the temperature was increased at 5° C./minute to obtain a loss tangent (tan δ) curve of the dynamic viscoelasticity. A value of a peak top observed in the curve was taken as a glass transition temperature (Tg).

### Softening Point

The softening point was measured by a Ring and Ball method according to JAI 7-1991.

### Production of Propylene Resin Composition

### Examples 1 to 11, Comparative Examples 1 to 2, and Reference Examples 1 to 5

The raw materials shown in Tables 1 to 5 were put in a 1-liter SUS container at a blending ratio shown in the respective Tables, were heated at 180° C. for 30 minutes to melt the raw materials, and were mixed and stirred with a three-one motor equipped with an anchor-type impeller for 15 minutes, thus obtaining a propylene resin composition. For the obtained propylene resin composition, the peel adhesion failure temperature (PAFT) and the semicrystallization time (t_{1/2}) were measured, and the bonding state at 70° C. was determined.

### Measurement of Peel Adhesion Failure Temperature (PAFT)

Each of the propylene resin compositions obtained in Examples and Comparative Examples was heated to 180° C. to melt the propylene resin composition. The molten resin composition was applied on a K-liner cardboard (K5 BF) (from Rengo Co., Ltd.) in a coating amount of 2.8 to 3.2 g/m using a coater manufactured by JT Toshi Co., Ltd. An open time of 2 seconds was taken and then the cardboard was bonded to another cardboard under conditions of a bonding pressure of 2 kg/25 cm² and a set time of 2 seconds to obtain a bonding test piece. The obtained bonding test piece was allowed to stand in an environment of 23° C. and a humidity of 50% for 24 hours, and then, using a holding power tester equipped with a thermohygrostat (BE-501, manufactured by TESTER SANGYO CO., LTD.), the bonding test piece was placed in an environment of 30° C. under no load for 30 minutes, and then, while applying a load of 200 g in a 180-degree peeling direction, the test piece was allowed to stand for 30 minutes. Subsequently, the temperature in the thermohygrostat was increased at a rate of 30° C./hour and the temperature at which the bonded sample was dissociated was measured. The measurement in the test was performed on five points, and the average was taken as a value of PAFT of the propylene resin composition obtained in each of Examples and Comparative Examples.

### Measurement of Semicrystallization Time (t_{1/2})

For each of the propylene resin compositions obtained in Examples and Comparative Examples, using a diffraction scanning calorimeter (“DSC-7” manufactured by PerkinElmer, Co., Ltd.), 10 mg of a sample was kept at 220° C. under a nitrogen atmosphere for 5 minutes, then, the temperature was decreased to 25° C. at 320° C./minute, and then, the sample was kept for 30 minutes to measure the variation in the calorific value in an isothermal crystallization process. Specifically, a line connecting two points with no change in the calorific value was taken as a base line, and such a time that an area surrounded by a line segment including a peak in a crystallization exothermic curve obtained by the DSC measurement, the base line, and a vertical line relative to the base line is half of the peak area was determined, and the time was taken as the semicrystallization time (t_{1/2}).

Note that, a case where no exothermic peak was observed in the isothermal crystallization process because crystallization was completed in the course of the temperature decrease was determined as “not measurable”.

### Determination of Bonding State at 70° C.

Each of the propylene resin compositions obtained in Examples and Comparative Examples was heated to 180° C. to melt the propylene resin composition.

The molten resin composition was applied on a K-liner cardboard (K5 BF) (from Rengo Co., Ltd.) in a coating amount of 2.8 to 3.2 g/m using a coater manufactured by JT Toshi Co., Ltd. An open time of 2 seconds (OT=2 seconds) was taken and then, the cardboard was bonded to another cardboard under conditions of a bonding pressure of 2 kg/25 cm² and a set time of 2 seconds to obtain a bonding test piece. Separately, an open time of 15 seconds (OT=15 seconds) was taken and then, the cardboard was bonded to another cardboard under conditions of a bonding pressure of 2 kg/25 cm² and a set time of 2 seconds to obtain a bonding test piece. Each of the obtained bonding test pieces was allowed to stand in an environment of 23° C. and a humidity of 50% for 24 hours, and then, with a holding power tester equipped with a thermohygrostat (BE-501, manufactured by TESTER SANGYO CO., LTD.), the bonding test piece was placed in an environment of 30° C. under no load for 30 minutes, and then, while applying a load of 200 g in a 180-degree peeling direction, the test piece was allowed to stand for 30 minutes. Subsequently, the temperature in the thermohygrostat was increased at a rate of 30° C./hour, and the bonding state of the bonding test piece at 70° C. was checked. A case where the bonding state of the bonding test piece was maintained was rated as “A” and a case where the bonding test piece was peeled was rated as “B”.

TABLE 1

| | | | | Reference | Reference | | | | |
|---|---|---|---|---|---|---|---|---|---|
| | | | | Example 1 | Example 2 | Example 1 | Example 2 | Example 3 | Example 4 |
| Configuration of | Propylene | A-1: L-MODU S400 | % by mass | 100 | 97.5 | 95 | 90 | 85 | 65 |
| resin composition | homopolymer, | A-2: Production | % by mass | — | — | — | — | — | — |
| | etc. | Example 1 | | | | | | | |
| | | a-3: Licocene 2602 | % by mass | — | — | — | — | — | — |
| | | a-4: Koattro 1200M | % by mass | — | — | — | — | — | — |
| | Propylene- | B-1: NP50605 | % by mass | — | 2.5 | 5 | 10 | 15 | 35 |
| | based polymer | B-2: MODIC 948 | % by mass | — | — | — | — | — | — |

| | | | | | | | | |
|---|---|---|---|---|---|---|---|---|
| Physical properties | Peel adhesion failure temperature (PAFT) | ° C. | 63 | 68 | 78 | 84.6 | 86.1 | 104 |
| of resin composition | Semicrystallization time (t_{1/2}) | second | 1200 | 278 | 205 | 147 | 113 | 75 |

| | | | | | | Comparative | Comparative |
|---|---|---|---|---|---|---|---|
| | | | | Example 5 | Example 6 | Example 1 | Example 2 |
| Configuration of | Propylene | A-1: L-MODU S400 | % by mass | 95 | — | — | — |
| resin composition | homopolymer, | A-2: Production | % by mass | — | 95 | — | — |
| | etc. | Example 1 | | | | | |
| | | a-3: Licocene 2602 | % by mass | — | — | 95 | — |
| | | a-4: Koattro 1200M | % by mass | — | — | — | 95 |
| | Propylene- | B-1: NP50605 | % by mass | — | 5 | 5 | 5 |
| | based polymer | B-2: MODIC 948 | % by mass | 5 | — | — | — |

| | | | | | | |
|---|---|---|---|---|---|---|
| Physical properties | Peel adhesion failure temperature (PAFT) | ° C. | 82 | 97 | 62 | 70 |
| of resin composition | Semicrystallization time (t_{1/2}) | second | 153 | 85 | Not | 240 |
| | | | | | measurable | |

TABLE 2

| | | | | Reference | Reference | | | | |
|---|---|---|---|---|---|---|---|---|---|
| | | | | Example 1 | Example 2 | Example 1 | Example 2 | Example 3 | Example 4 |
| Configuration of | Propylene | A-1: L-MODU S400 | % by mass | 100 | 97.5 | 95 | 90 | 85 | 65 |
| resin composition | homopolymer, | A-2: Production | % by mass | — | — | — | — | — | — |
| | etc. | Example 1 | | | | | | | |
| | | a-3: Licocene 2602 | % by mass | — | — | — | — | — | — |
| | | a-4: Koattro 1200M | % by mass | — | — | — | — | — | — |
| | propylene- | B-1: NP50605 | % by mass | — | 2.5 | 5 | 10 | 15 | 35 |
| | polymer based | B-2: MODIC 948 | % by mass | — | — | — | — | — | — |

| | | | | | | | | |
|---|---|---|---|---|---|---|---|---|
| Evaluation of | Bonding state at 70° C. (OT = 2 seconds) | — | B | B | A | A | A | A |
| resin composition | Bonding state at 70° C. (OT = 15 seconds) | — | B | B | A | A | A | A |

| | | | | | | Comparative | Comparative |
|---|---|---|---|---|---|---|---|
| | | | | Example 5 | Example 6 | Example 1 | Example 2 |
| Configuration of | Propylene | A-1: L-MODU S400 | % by mass | 95 | — | — | — |
| resin composition | homopolymer, | A-2: Production | % by mass | — | 95 | — | — |
| | etc. | Example 1 | | | | | |
| | | a-3: Licocene 2602 | % by mass | — | — | 95 | — |
| | | a-4: Koattro 1200M | % by mass | — | — | — | 95 |
| | propylene- | B-1: NP50605 | % by mass | — | 5 | 5 | 5 |
| | polymer based | B-2: MODIC 948 | % by mass | 5 | — | — | — |

| | | | | | | |
|---|---|---|---|---|---|---|
| Evaluation of | Bonding state at 70° C. (OT = 2 seconds) | — | A | A | B | A |
| resin composition | Bonding state at 70° C. (OT = 15 seconds) | — | A | A | B | B |

TABLE 3

| | | | | | | Reference | | Reference |
|---|---|---|---|---|---|---|---|---|
| | | | | Example 7 | Example 8 | Example 3 | Example 9 | Example 1 |
| Configuration of | Propylene | A-1: L-MODU S400 | % by mass | 95 | 65 | 95 | — | 100 |
| resin composition | homopolymer | A-2: Production | % by mass | — | — | — | 100 | — |
| | | Example 1 | | | | | | |
| | Propylene- | B-3: Y-2045GP | % by mass | 5 | 35 | — | — | — |
| | based polymer | B-4: NP506 | % by mass | — | — | 5 | — | — |

| | | | | | | | |
|---|---|---|---|---|---|---|---|
| Physical properties | Peel adhesion failure temperature (PAFT) | ° C. | 70 | 107 | 64 | 88 | 63 |
| of resin composition | Semicrystallization time (t1/2) | second | 172 | 68 | 204 | 87 | 1200 |

TABLE 4

| | | | | | | Reference | | Reference |
|---|---|---|---|---|---|---|---|---|
| | | | | Example 7 | Example 8 | Example 3 | Example 9 | Example 1 |
| Configuration of | Propylene | A-1: L-MODU S400 | % by mass | 95 | 65 | 95 | — | 100 |
| resin composition | homopolymer | A-2: Production | % by mass | — | — | — | 100 | — |
| | | Example 1 | | | | | | |
| | Propylene- | B-3: Y-2045GP | % by mass | 5 | 35 | — | — | — |
| | based polymer | B-4: NP506 | % by mass | — | — | 5 | — | — |

| | | | | | | | |
|---|---|---|---|---|---|---|---|
| Evaluation of | Bonding state at 70° C. (OT = 2 seconds) | — | A | A | B | A | B |
| resin composition | Bonding state at 70° C. (OT = 15 seconds) | — | A | A | B | A | B |

TABLE 5

| | | | | | Reference | | Reference |
|---|---|---|---|---|---|---|---|
| | | | | Example 10 | Example 4 | Example 11 | Example 5 |
| Configuration of | Propylene | A-1: L-MODU S400 | % by mass | 85 | 90 | 55.25 | 85 |
| resin composition | homopolymer | | | | | | |
| | Propylene- | B-1: NP50605 | % by mass | 5 | | 29.75 | |
| | based polymer | | | | | | |
| | Ethylene- | C-1: Affinity GA 1950 | % by mass | 10 | 10 | | |
| | based polymer | | | | | | |
| | Tackifying | Escorez 5300 | % by mass | | | 15 | 15 |
| | resin | | | | | | |

| | | | | | | |
|---|---|---|---|---|---|---|
| Physical properties | Peel adhesion failure temperature (PAFT) | ° C. | 80 | 61 | 96 | 54 |
| of resin composition | Semicrystallization time (t1/2) | second | 153 | 274 | 117 | 2040 |

As can be seen from the result of Tables 1 to 5, the propylene resin composition of the present invention can stably exhibit a good adhesiveness even under high temperature conditions. In addition, the propylene resin composition of the present invention can maintain a high heat-creeping resistance (heat resistance) even with a long open time.

1. A propylene resin composition comprising a propylene homopolymer (A) that satisfies conditions (1) to (3) described below, and having a semicrystallization time (t_{1/2}) of 60 seconds or more:
(1) having a melting point (Tm-D) of 120° C. or lower;
(2) having a molecular weight distribution (Mw/Mn) less than 3.0;
(3) having a melt viscosity at 190° C. of 30,000 mPa·s or less.

2. The propylene resin composition according to claim 1, wherein the propylene homopolymer (A) is comprised in an amount of 40% by mass or more and less than 98% by mass.

3. The propylene resin composition according to claim 1, further comprising a propylene-based polymer (B) that has a melting point higher than 120° C.

4. The propylene resin composition according to claim 3, wherein the propylene-based polymer (B) is an acid-modified propylene-based polymer.

5. The propylene resin composition according to claim 3, wherein the propylene-based polymer (B) is a maleic acid-modified propylene-based polymer.

6. The propylene resin composition according to claim 3, wherein the propylene-based polymer (B) is an unmodified propylene-based polymer that has a weight average molecular weight (Mw) of 40,000 or more.

7. The propylene resin composition according to claim 3, wherein the propylene-based polymer (B) is comprised in an amount of 1 to 40% by mass.

8. The propylene resin composition according to claim 1, further comprising an ethylene-based polymer (C) in an amount of 1 to 50% by mass.

9. The propylene resin composition according to claim 1, having a peel adhesion failure temperature (PAFT) of 70° C. or higher.

10. The propylene resin composition according to claim 1, wherein the propylene homopolymer (A) is comprised in an amount of 98% by mass or more and the melting point (Tm-D) of the propylene homopolymer (A) is 95° C. or higher.

11. A hot-melt adhesive comprising the propylene resin composition according to claim 1.
